(19) United States
(12) Patent Application Publication
(10) Pub. No.: US 2026/0277663 A1
(43) Pub. Date: Sep. 17, 2026

(54) DEVICE MANAGEMENT DEVICE, DEVICE MANAGEMENT METHOD, AND STORAGE MEIDUM

(71) Applicant: CANON KABUSHIKI KAISHA, Tokyo (JP)

(72) Inventor: MOMOE UCHIDA, Kanagawa (JP)

(21) Appl. No.: 19/549,210

(22) Filed: Feb. 25, 2026

(30) Foreign Application Priority Data
Mar. 13, 2025 (JP) 2025-040754

(51) Int. Cl. G06F 9/48; G06F 3/0482

(52) U.S. Cl. CPC G06F 9/4843; G06F 3/0482

(57) ABSTRACT

A device management device that performs registration and management of tasks performs: managing devices to be managed by groups; managing the tasks to be executed for each device group; editing a layout at the time of displaying a device list and registering the layout in correlation with a predetermined device group; and displaying the device list on the basis of the layout registered through the managing of a layout.

### BACKGROUND

### Field of the Technology

The present disclosure relates to a device management device, a device management method, and a storage medium.

### Description of the Related Art

In recent years, a management device has been able to acquire various types of information such as operation statuses or consumables from image forming apparatuses such as printers and multifunction machines (hereinafter referred to as devices) in remote places connected to a network. Various types of information which can be set in the devices can be collectively transmitted.

For example, when residual quantities or the like of consumables are ascertained, it is conceivable that a manager of the management device prepare device groups by faculties of devices such as a color machine and a monochrome machine and ascertain such information for each group. Since a color machine includes color toners/inks and a monochrome machine includes only a black toner/ink, attribute values to be ascertained are different according to the device groups.

The manager ascertains device states according to the purposes by registering a combination of attribute values to be displayed as a layout according to application thereof and switching the layout. For example, a layout in which residual quantities of color toners/inks are to be displayed for the group of color machines or only a residual quantity of a black toner/ink is to be displayed for the group of monochrome machines is registered.

Japanese Unexamined Patent Publication No. H10-23687 discloses a method of realizing display of device states in the units of groups by preparing a device management table.

In the method disclosed in Japanese Unexamined Patent Publication No. H10-23687, the device states can be displayed in the units of groups, and a device can belong to only one group. Since only one display pattern can be displayed for each group, for example, it is difficult to switch the same group to different display modes such as consumable residual check and alert occurrence situation check.

### SUMMARY

According to an aspect of the present disclosure, there is provided a device management device that performs registration and management of tasks, the device management device performing: managing devices to be managed by groups; managing the tasks to be executed for each device group; editing a layout at the time of displaying a device list and registering the layout in correlation with a predetermined device group; and displaying the device list on the basis of the layout registered through the managing of a layout.

Further features of the present disclosure will become apparent from the following description of embodiments with reference to the attached drawings.

### BRIEF DESCRIPTION OF THE DRAWINGS

FIG. 1 is a diagram illustrating an example of a network configuration according to a first embodiment of the present disclosure.

FIG. 2 is a diagram illustrating an example of a hardware configuration according to the first embodiment.

FIG. 3 is a functional block diagram illustrating an example of a software configuration of a device management device 102 according to the first embodiment.

FIG. 4 is a diagram illustrating an example of a UI of a device information managing unit 310 that is displayed on a display 207 of the device management device 102 according to the first embodiment.

FIG. 5 is a diagram illustrating an example of a UI of a layout information managing unit 330 that is displayed on the display 207 of the device management device 102 according to the first embodiment.

FIG. 6 is a diagram illustrating an example of the UI of the layout information managing unit 330 that is displayed on the display 207 of the device management device 102 according to the first embodiment.

FIG. 7 is a diagram illustrating an example of the UI of the layout information managing unit 330 that is displayed on the display 207 of the device management device 102 according to the first embodiment.

FIGS. 8A and 8B are diagrams illustrating an example of a device management screen of the device information managing unit 310 to which a default layout is applied according to the first embodiment.

FIG. 9 is a flowchart illustrating an example of a device management method that is performed by the layout information managing unit 330 according to the first embodiment.

FIG. 10 is a flowchart illustrating an example of a device list displaying process flow that is performed by the device information managing unit 310 according to the first embodiment.

FIG. 11 is a diagram illustrating an example of a layout registration screen of a device management device 102 according to a second embodiment.

FIG. 12 is a diagram illustrating an example of a UI of a layout information managing unit 330 that is displayed on the display 207 of the device management device 102 according to the second embodiment.

FIG. 13 is a diagram illustrating an example of a UI of a task information managing unit 320 that is displayed on the display 207 of the device management device 102 according to the second embodiment.

FIG. 14 is a diagram illustrating an example of a UI of a task managing unit 321 that is displayed on the display 207 of the device management device 102 according to the second embodiment.

FIG. 15 is a diagram illustrating an example of a UI of the task managing unit 321 that is displayed on the display 207 of the device management device 102 according to the second embodiment.

FIG. 16 is a diagram illustrating an example of a UI of a layout information managing unit 330 that is displayed on a display 207 of a device management device 102 according to a third embodiment.

FIG. 17 is a flowchart illustrating an example of a queue identifying process flow in a layout managing unit embodiment according to the third embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

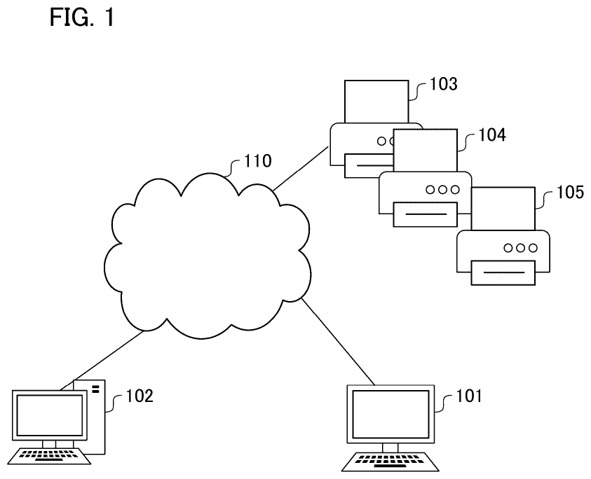

FIG. 1 is a diagram illustrating an example of a network configuration according to a first embodiment of the present disclosure. 101 and 102 denote a client and a management device of which each is constituted by an information processing device such as a personal computer. The client 101 and the device management device 102 are connected to a network 110 via a network cable such as Ethernet (registered trademark) or wirelessly.

The client 101 and the device management device 102 each have a printer driver that can execute various programs such as an application program and has a function of converting print data to a printer language corresponding to a printer. The client 101 and the device management device 102 each include a communication device that can communicate interactively with another device connected to the network 110.

A control program for realizing various types of control is stored in a storage medium such as an HD or a ROM of the client 101 and the device management device 102 in an executable manner, and the printer driver supports a plurality of printers. A printer (an input/output device) may be any of various types such as a laser beam printer employing an electrophotography system, an inkjet printer employing an inkjet system, and a printer using a thermal transfer system.

The device management device 102 includes a communication device that can communicate interactively with another device connected to the network 110 and performs state monitoring and various settings of an information processing device such as the client 101. The device management device 102 performs a device management device which will be described later such as registration and management of tasks of an information processing device such as the client 101. The device management device 102 may also have a function of a client.

103 to 105 denote printing devices (which include a single-function printer, a copier, and a multifunction machine), serve as network printers, and are connected to the network 110 via network interfaces.

The printing devices 103 to 105 receive a print job including print data transmitted from the client 101 and perform printing. The client 101, the device management device 102, the printing devices 103 to 105, and the like are connected to the network 110.

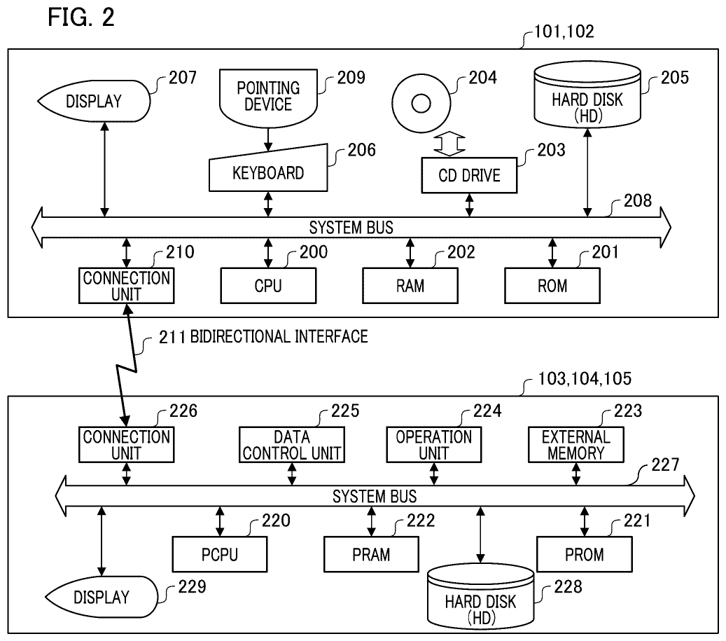

FIG. 2 is a diagram illustrating an example of a hardware configuration according to the first embodiment, and the configurations of the client 101 and the device management device 102 will be first described. In the client 101 and the device management device 102, 200 denotes a CPU which is a computer of each of the client 101 and the device management device 102. The CPU 200 executes an application program, a printer driver program, an OS, and a network printer control program according to the present embodiment, and the like stored in a hard disk (HD) 205.

201 denotes a ROM which is a storage means, and programs such as a basic I/O program and various types of data such as font data used for document processing and template data are stored therein. 202 denotes a RAM which is a temporary storage means and serves as a main memory and a work area of the CPU 200.

203 denotes an optical disc (CD) driver which is a storage medium reading means. The storage means is not limited to a CD-ROM and may be an arbitrary one of a CD-R, CD-RW, a PC card, a DVD, a memory card, an MO, and the like. 204 denotes a CD, and a computer program which can be read by a computer is stored therein.

205 denotes a hard disk (HD) which is an external storage means, and an application program, a printer driver program, an OS, a control program, a related program, and the like are stored therein.

206 denotes a keyboard which receives an input of an instruction such as a control command for a device. 207 denotes a display and displays a command input from the keyboard 206, a printer state, and the like.

208 denotes a system bus which takes charge of a flow of data in a computer which is a client. 209 denotes a pointing device and an instruction unit that receives a user's instruction. 210 denotes a connection unit which performs transmission and reception of data to and from an external device via a bidirectional interface 211.

Detailed configurations of the printing devices 103 to 105 will be described below. Each of the printing devices 103 to 105 includes a connection unit 226, a data control unit (a printer engine) 225, an operation unit 224, an external memory 223, a PCPU 220, a PRAM 222, and a PROM 221. These constituents are connected to each other via a system bus 227.

A printer CPU (PCPU) 220 which is a computer takes charge of control of all the printing devices 103 to 105. The PCPU 220 transmits an image signal out of a printer control command (transmission data) received by the connection unit 226 to the data control unit 225 on the basis of a control program stored in the PROM 221 or the external memory 223 which will be described later.

The PROM 222 is a main memory of the PCPU 220 and includes a temporary storage area of various types of data which is used as a work data area at the time of performing of control by the PCPU 220. The external memory 223 is connected as an option and stores font data, an application program, form data, and the like.

The PROM 221 is a printer internal memory and stores various types of data, a control program for controlling the corresponding printing device, or the like similarly to an external memory. The data control unit 225 is a printer engine, is controlled by the PCPU 220, receives an image signal output via the system bus 227 by a control program stored in the PROM 221 or the external memory 223, and performs an actual printing process.

The operation unit 224 includes an input unit such as an operation panel or an operation switch and a display unit such as an LED or a liquid crystal panel, receives an operator's operation, and displays a result. An operator can instruct and ascertain settings of the printing devices 103 to 105 via the operation unit 224.

226 denotes a connection unit which is connected to the client 101 and the connection units 210 of the device management device 102 via the bidirectional interface 211 and which can receive a print control command (transmission data) and notify of printing device internal states or the like. The hardware devices can be replaced with software for realizing functions corresponding to the devices.

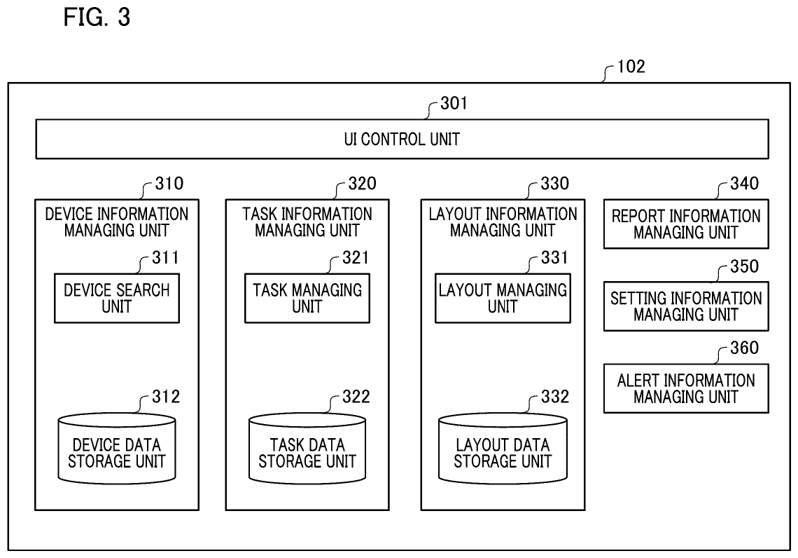

FIG. 3 is a functional block diagram illustrating an example of a software configuration of the device management device 102 according to the first embodiment. Some of functional blocks illustrated in FIG. 3 are realized by causing the CPU 200 which is a computer included in the device management device 102 or the like to execute a computer program stored in a memory which is a storage medium.

However, some or all of the functional blocks may be realized by hardware. A dedicated circuit (ASIC), a processor (a reconfigurable processor, a DSP), or the like can be used as the hardware. The functional blocks illustrated in FIG. 3 may not be provided in the same housing and may be constituted by different devices connected to each other via a signal line.

The device management device 102 includes a user interface (UI) control unit 301, a device information managing unit 310, a task information managing unit 320, a layout information managing unit 330, a report information managing unit 340, a setting information managing unit 350, and an alert information managing unit 360.

The UI control unit 301 takes charge of UI control. The UI control unit 301 can also be realized as a web-based application. In this case, the UI control unit 301 performs UI control via a web browser. The device information managing unit 310 manages information of devices which are managed by the device management device 102 and serves as a device management means for performing a device managing step of managing devices to be managed by groups.

The device information managing unit 310 includes a device search unit 311 and a device data storage unit 312. The device search unit 311 has a device search function, for example, based on simple network management protocol (SNMP), IP broadcast, or SLIP/multicast.

The device search unit 311 performs search on devices connected to the network 110 at an arbitrary timing. The device search unit 311 has a function of acquiring/changing device information such as management information base (MIB) via a communication line such as a LAN.

The device search unit 311 acquires device information such as a device name, a product name, and an IP address as a result of device search and stores the device information in the device data storage unit 312 which will be described later. The device data storage unit 312 is a data recording medium such as a database and stores table data such as a device list.

The task information managing unit 320 manages information of tasks which are managed by the device management device 102. The task information managing unit 320 includes a task managing unit 321 and a task data storage unit 322. The task managing unit 321 performs a predetermined task according to a target device, setting information, and a schedule which are designated by a manager via the UI control unit 301.

The task information managing unit 320 serves as a task information managing means for performing a task information managing step of managing tasks to be performed for a device group. The task data storage unit 322 stores data on each task (for example, an execution result, schedule setting, task issuance conditions, and an execution target device).

The layout information managing unit 330 manages information of layouts which are managed by the device management device 102. The layout information managing unit 330 includes a layout managing unit 331 and a layout data storage unit 332. The layout managing unit 331 receives a layout registration/change instruction or the like from a manager via the UI control unit 301 and stores the layout registration/change instruction or the like in the layout data storage unit 332.

The layout data storage unit 332 stores data on layouts (for example, queue names to be displayed and a target device group). Here, the layout managing unit 331 serves as a layout managing means for performing a layout managing step of editing a layout and registering the layout in correlation with a predetermined device group.

The report information managing unit 340 manages information of reports which are managed by the device management device 102. The setting information managing unit 350 manages setting information which is managed by the device management device 102. The alert information managing unit 360 manages alert information which is managed by the device management device 102.

Management tables of the device management device 102 will be described below with reference to Tables 1 to 4. Table 1 shows an example of a device table. In the device table, devices managed by the device management device 102 are recorded one by one record, and each record includes a device ID as identification information issued by the device management device 102.

TABLE 1
Device Table

| Index | Device ID | Device model | IP address | serial No. |
|---|---|---|---|---|
| 0 | DV1 | MFP_001 | 192.10.10.10 | AAA00001 |
| 1 | DV2 | MFP_002 | 192.10.11.30 | AAA00002 |
| 2 | DV3 | MFP_003 | 192.10.12.50 | AAA00003 |

Table 2 shows an example of a group table. Device groups managed by the device management device 102 are recorded one by one record. Each record includes one group ID as identification information issued by the device management device 102 and includes device IDs of one or more devices belonging to each group.

TABLE 2
Group Table

| | | | Number of | |
|---|---|---|---|---|
| Index | Group ID | Group name | devices | Device ID |
| 0 | GP1 | Color machine | 15 | DV1, DV2, . . . |
| 1 | GP2 | Monochrome | 20 | DV21, DV22, |
| | | machine | | . . . |
| 2 | GP3 | Kawasaki area | 20 | DV1, DV31, |
| | | | | . . . |

Table 3 shows an example of a task table. Tasks managed by the device management device 102 are recorded one by one record. Each record includes one task ID as identification information issued by the device management device 102. In the task table shown in Table 3, an example in which a group ID is included as information for identifying a device on which a task is to be executed is shown, but the present disclosure is not limited thereto and a device ID may be used.

TABLE 3
Task Table

| Index | Task ID | Task name | Type | Start | End | Group ID | Interval | |
|---|---|---|---|---|---|---|---|---|
| 0 | TSK1 | Delivery of | Repeat | 2024 Jan. 1 | 2025 Jan. 1 | GP1 | 24 | H |
| | | network | | 0:00 | 0:00 | | | |
| | | setting | | | | | | |
| | | value | | | | | | |
| 1 | TSK2 | Consumable | Repeat | 2025 Jan. 25 | 2025 Jan. 25 | GP2 | 1 | M |
| | | report | | 23:00 | 23:00 | | | |

| | | | | | |
|---|---|---|---|---|---|
| 2 | TSK3 | Backup | One | 2024 Jan. 10 | GP1, |
| | | | time | 1:00 | GP2, |
| | | | | | GP3 |

Table 4 shows an example of a layout table. Layouts managed by the device management device 102 are recorded one by one record. Each record includes one layout ID as identification information issued by the device management device 102. Each record includes queue names displayed in a layout, group IDs as information for identifying device groups used in a layout, and attribute information indicating whether a device group is to use a default layout.

TABLE 4
Layout Table

| | Layout | Layout | Queue | Default | Group |
|---|---|---|---|---|---|
| Index | ID | name | name | setting ON | ID |
| 0 | LYT1 | Layout for | Serial No., cyan | GP1 | GP1, GP3 |
| | | color | ink/residual toner, | | |
| | | machine | . . . | | |
| 1 | LYT2 | Layout for | Serial No., black | GP2 | GP2, GP3 |
| | | monochrome | ink/residual toner, | | |
| | | machine | . . . | | |
| 2 | LYT3 | Layout for | Device model, IP | GP3 | GP3 |
| | | Kawasaki | address, | | |
| | | area | installation | | |
| | | | place, . . . | | |

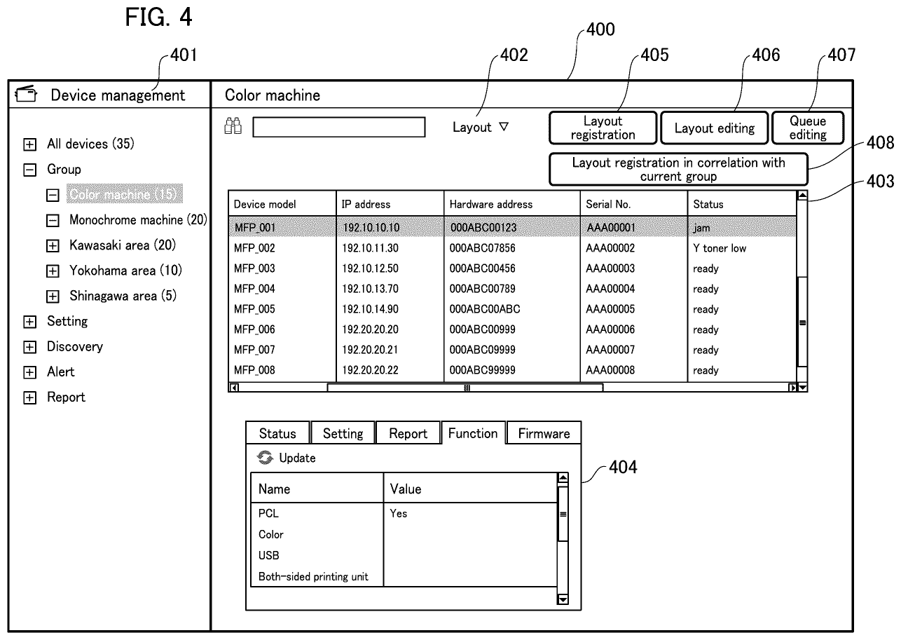

UIs of a device information management screen 400 which is displayed on the display 207 by the device management device 102 will be described below with reference to FIGS. 4 to 7.

FIG. 4 is a diagram illustrating an example of a UI of the device information managing unit 310 displayed on the display 207 by the device management device 102 according to the first embodiment, where 401 denotes a device management area. In the device management area 410, groups of devices to be managed such as “all devices” and menus of the functions of the device management device 102 such as “setting,” “discovery,” “alert,” and “report” are displayed in the form of a tree.

402 denotes a function display area, and display details thereof are changed with selection of a menu displayed in the device management area 401. 403 denotes a device list in the table form for displaying devices belonging to a selected device group along with accessory information in a list when the device group is selected from the device management area 401 of the device information management screen 400 by a manager.

404 denotes an area in which information (for example, a status, setting information, a report, a function, and firmware) on a device selected from the device list 403 by a manager is displayed. 405 denotes a button “layout registration” for allowing a manager to register a layout of the device list 403.

406 denotes a button “layout editing” for allowing a manager to edit the layout of the device list 403. 407 denotes a button “queue editing” for allowing a manager to edit a queue of the layout of the displayed device list 403.

A manager can change the layout displayed in the device list 403 by pushing the button “queue editing” 407. By pushing the button “layout registration” 405, the manager can register the layout of the device list 403 edited using the button “queue editing” 407 as an arbitrary layout.

408 denotes a button “layout registration in correlation with current group” for allowing a manager to register the layout of the device list 403 which is currently displayed in correlation with the selected device group. This button is valid only when a device group is selected in the device management area 401 and is invalid when no device group is selected.

The UI illustrated in FIG. 4 according to the first embodiment is an example of the UI of the device information managing unit 310. The button “layout registration” 405, the button “layout editing” 406, and the button “queue editing” 407 in FIG. 4 may be displayed on the UIs of the task information managing unit 320, the report information managing unit 340, and the like. The functions in FIG. 4 are not limited to the example illustrated in FIG. 4, and all functions of the device management device 102 accompanying display of a device list may be used.

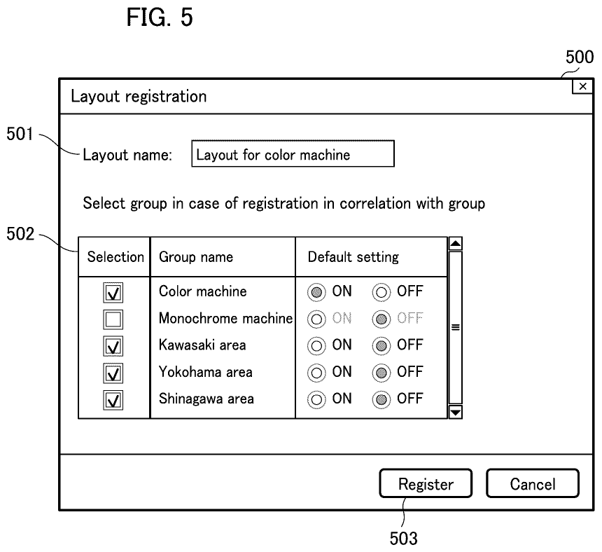

FIG. 5 is a diagram illustrating an example of a UI of the layout information managing unit 330 displayed on the display 207 of the device management device 102 according to the first embodiment.

500 denotes a layout registration screen which is displayed when the button “layout registration” 405 of FIG. 5 is pushed by a manager. 501 denotes a layout name input area, and an arbitrary layout name can be input thereto. 502 denotes a device group selection and setting area, and a plurality of group names can be selected using checkboxes. One layout can be set as a default for each group.

A default setting area is valid for only a device group of which the checkbox is ON and is invalid when the checkbox is OFF. In FIG. 5, control is performed using a checkbox and a radio button, but the present disclosure is not limited thereto.

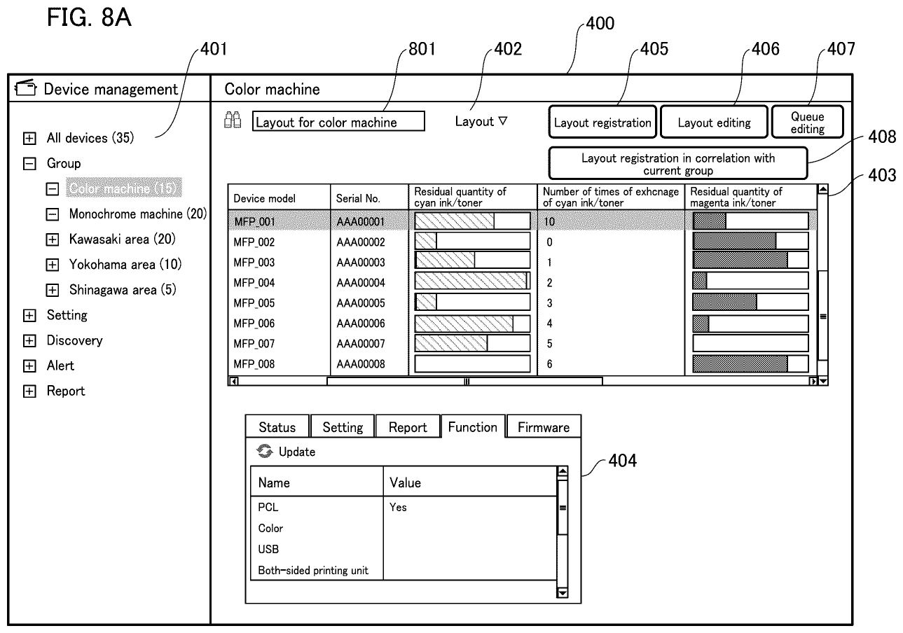

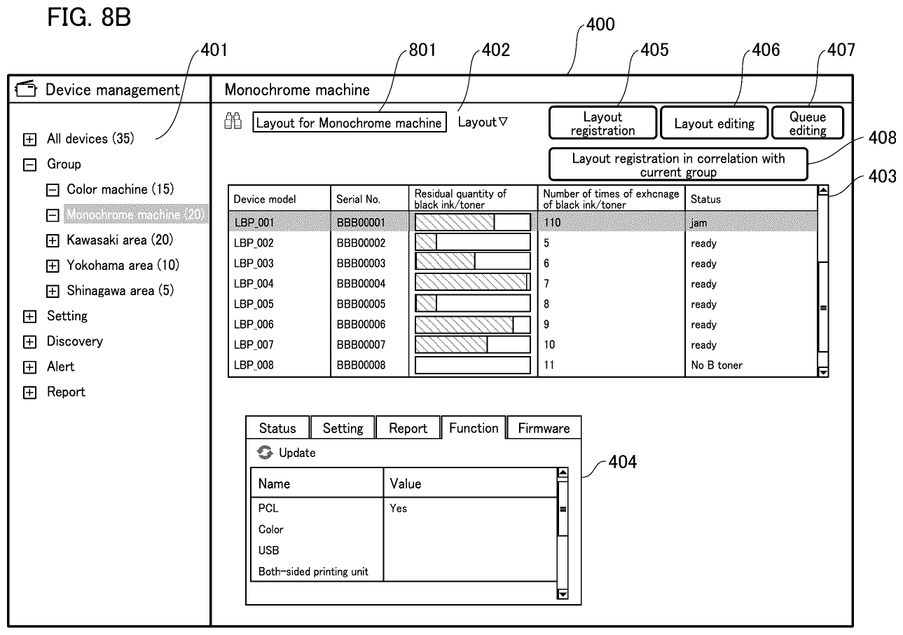

503 denotes a button “registration.” When the button 503 is pushed, a layout is registered under the conditions set on the layout registration screen 500. Specifically, a layout record is registered in the layout data storage unit 332. The process of registration will be described later in details with reference to the flowchart illustrated in FIG. 8.

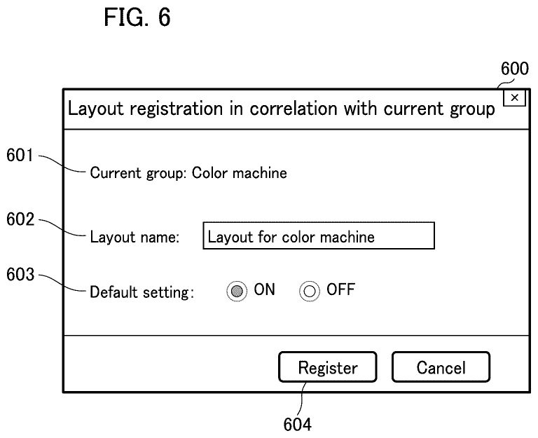

FIG. 6 is a diagram illustrating an example of a UI of the layout information managing unit 330 displayed on the display 207 of the device management device 102 according to the first embodiment.

600 denotes a layout registration screen which is displayed when the button “layout registration in correlation with current group” 408 of FIG. 4 is pushed by a manager. 601 denotes an area in which a currently selected device group is displayed.

602 denotes a layout name input area, and an arbitrary layout name can be input thereto. 603 denotes an area in which a registered layout is to be set as a default of the currently selected device group.

604 denotes a button “registration.” When the button 604 is pushed, a layout is registered in correlation with a device group under the conditions set on the layout registration screen 600. Specifically, the layout record is registered in the layout data storage unit 332.

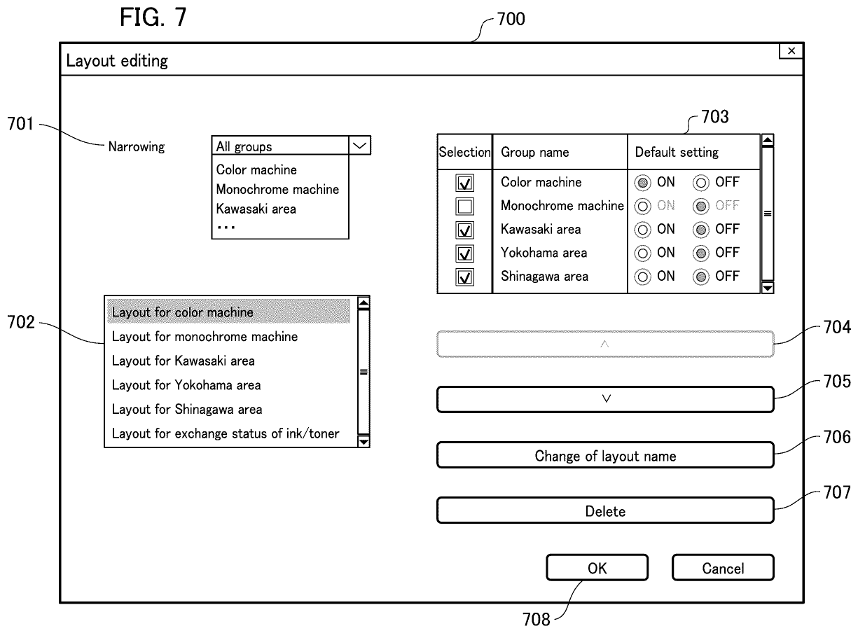

FIG. 7 is a diagram illustrating an example of a UI of the layout information managing unit 330 displayed on the display 207 of the device management device 102 according to the first embodiment.

700 denotes a layout editing screen which is displayed when the button “layout editing” 406 in FIG. 4 is pushed by a manager. 701 denotes a device group narrowing area. One or all of device groups registered in the device management device 102 can be selected.

702 denotes a selection and setting area of a layout to be edited. A layout name displayed in a combo box can be selected. The layout names of the layouts correlated with the device group selected in 701 are listed up. In FIG. 7, control is performed using a combo box, but the present disclosure is not limited thereto.

703 denotes a control area for changing settings correlated with a layout to be edited. The operation method is the same as that of 502 in FIG. 5, and thus description thereof will be omitted. 704 denotes a button “A.” When this button is pushed, the display order in the combo box is changed to be higher.

705 denotes a button “v.” When this button is pushed, the display order in the combo box is changed to be lower. The display order changed using the button 704 or 705 is the same as the order which is displayed when a layout is selected. 706 denotes a button “layout name change.” When this button is pushed, the layout name can be changed to an arbitrary layout name.

707 denotes a button “delete.” When this button is pushed, the layout managed by the layout data storage unit 332 is deleted. 708 denotes a button “OK.” When this button is pushed, the layout is changed to the conditions set on the layout editing screen 700.

FIGS. 8A and 8B are diagrams illustrating an example of a device management screen of the device information managing unit 310 to which a default layout is applied according to the first embodiment.

It is assumed that a “layout for color machines” for a color machine group is in a default setting ON state and a “layout for monochrome machines” for a monochrome machine group is in a default setting OFF state using the layout registration screen illustrated in FIG. 5. It is assumed that only the “layout for monochrome machines” is correlated with the monochrome machine group.

FIG. 8A is a diagram illustrating an example of the UI of the device information managing unit 310 when a “color machine” group is selected in the device management area 401.

801 denotes a layout name display area, and since the “layout for color machines” is registered as a default layout for a color machine group, the “layout for color machines” is displayed.

In FIG. 8A, the device list 403 is displayed using the layout displayed in the layout name display area 801, and values associated with a queue selected in the “layout for color machines” are displayed in the form of a table.

FIG. 8B is a diagram illustrating an example of the UI of the device information managing unit 310 when a “monochrome machine” group is selected in the device management area 401.

The “layout for monochrome machines” is displayed in the layout name display area 801. Since a default layout is not registered in the monochrome machine group and only the “layout for monochrome machines” is registered, the “layout for monochrome machines” is displayed.

In FIG. 8B, the device list 403 is displayed using the layout displayed in the layout name display area 801, and values associated with a queue selected in the “layout for monochrome machines” are displayed in the form of a table.

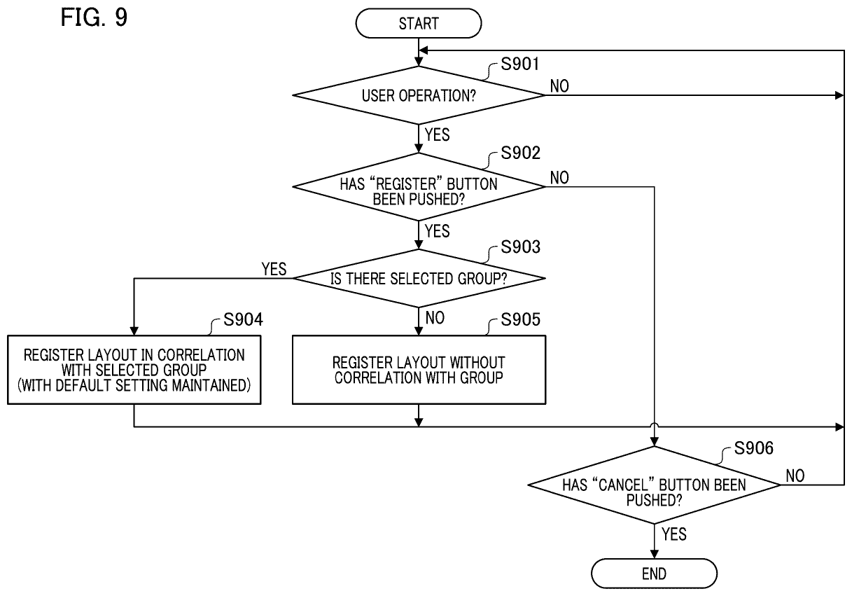

FIG. 9 is a flowchart illustrating an example of a device management method that is performed by the layout information managing unit 330 according to the first embodiment. The operations of the steps in the flowchart illustrated in FIG. 9 are sequentially performed by causing the CPU which is a computer in the device management device 102 or the like to execute a computer program stored in a memory.

In Step S901, a user operation is received. That is, it is determined whether an operation on the layout registration screen 500 has been performed using the pointing device 209, the keyboard 206, or the like by a manager (a user), and the process flow returns to Step S901 when the determination result is NO. On the other hand, when the determination result of Step S901 is YES, it is determined in Step S902 whether the operation is an operation of pushing the button “registration.”

When it is determined in Step S902 that the operation is an operation of pushing the button “registration,” it is determined in Step S903 whether there is a group selected on the layout registration screen 500.

When it is determined in Step S903 that there is a selected group, a layout is registered in correlation with the device group set in the device group selection and setting area 502 in Step S904. Specifically, a record of the layout table shown in Table 4 is newly prepared, and the record is registered in the layout data storage unit 332.

On the other hand, when it is determined in Step S903 that there is no selected group, a layout record not correlated with a device group is newly prepared, and the layout thereof is registered in Step S905.

When it is determined in Step S902 that the operation is not an operation of pushing the button “registration,” it is determined in Step S906 whether the operation is an operation of pushing a button “cancel.”

When it is determined in Step S906 that the operation is an operation of pushing the button “cancel,” the process flow illustrated in FIG. 9 ends, and the device information management screen 400 is displayed. When it is determined in Step S906 that the operation is not an operation of pushing the button “cancel,” the process flow returns to Step S901.

In the flowchart illustrated in FIG. 9, the layout registration screen 500 has been exemplified, and the same process is performed on the layout registration screen 600 and the layout editing screen 700. The flowchart illustrated in FIG. 9 and the process flow on the layout registration screen 600 are different in that the number of device groups to be correlated is one. The flowchart illustrated in FIG. 9 and the process flow on the layout editing screen 700 are different in that existing layout records are updated according to editing details of the layout editing screen 700.

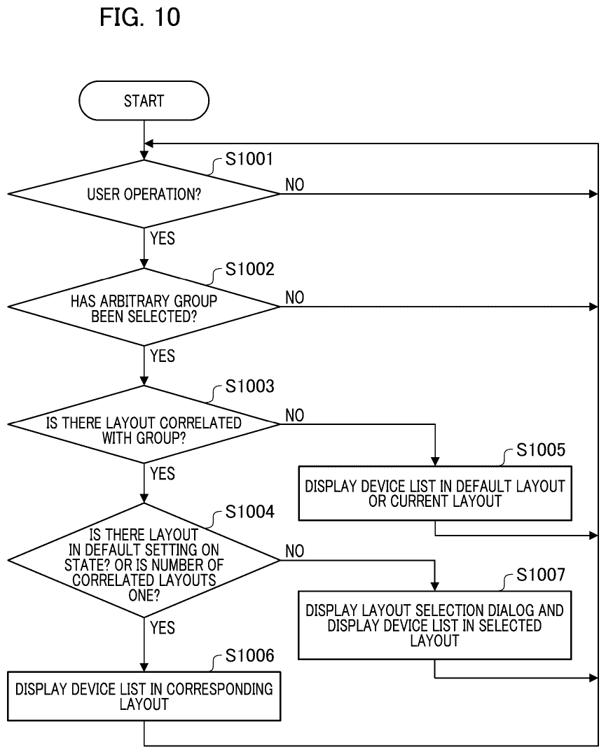

FIG. 10 is a flowchart illustrating an example of a device list display flow that is performed by the device information managing unit 310 according to the first embodiment. For the purpose of simplification of explanation, only points related to the present embodiment will be described below. The operations of the steps in the flowchart illustrated in FIG. 10 are sequentially performed by causing the CPU which is a computer in the device management device 102 or the like to execute a computer program stored in a memory.

In Step S1001, a user operation is received. That is, it is determined whether an operation on the device information management screen 400 has been performed using the pointing device 209, the keyboard 206, or the like by a manager (a user), and the process flow returns to Step S1001 when the determination result is NO. On the other hand, when the determination result of Step S1001 is YES, it is determined in Step S1002 whether the operation is an operation of selecting an arbitrary device group.

When it is determined in Step S1002 that an arbitrary device group has been selected, it is determined in Step S1003 whether there is a layout correlated with the selected device group. Specifically, it is checked whether there is a layout record correlated with the selected device group in the layout records managed by the layout data storage unit 332.

When the determination result of Step S1003 is NO, a device list is displayed in the currently displayed layout in Step S1005. Alternatively, when a default layout is managed in the device management device 102, the device list is displayed using the default layout. FIG. 8A illustrates an example of a UI when there is a layout in the default setting ON state. Thereafter, the process flow returns to Step S1001.

When the determination result of Step S1003 is YES, it is determined in Step S1004 whether there is a layout in the default setting ON state or whether the number of layouts determined in Step S1003 is one.

When the determination result of Step S1004 is YES, the device list is displayed in the layout in Step S1006. FIG. 8B illustrates an example of the UI when there is no layout in the default setting ON state and the number of layouts correlated with a group is one. Thereafter, the process flow returns to Step S1001.

When it is determined in Step S1004 that there is no layout in the default setting ON state and the number of layouts correlated with a device group is two or more, a layout selection dialog is displayed in Step S1007 and the device list is displayed in the selected layout. At that time, the device list may be displayed using a layout identified according to an arbitrary rule, for example, a newest registration date and time, instead of displaying the layout selection dialog.

Here, Steps S1005 to S1007 serve as a display control step (a display control means) of displaying the device list on the basis of a layout registered in the layout managing step.

Through the flowcharts illustrated in FIGS. 9 and 10 described above, the device management device 102 can display a device list with a simple operation using a layout correlated with the device group registered on the layout registration screen 500.

In the first embodiment, an example in which a layout is registered in correlation with a device group has been described. In the device management device 102 according to the first embodiment, the task information managing unit 320, the report information managing unit 340, or the like in addition to the device information managing unit 310 has the function of displaying a device list.

### Second Embodiment

In a second embodiment, a method of registering and using a layout correlated with a function with a likelihood that a device list will be displayed in addition to a layout correlated with a device group will be described. An example of a layout table in the second embodiment is shown in Table 5.

TABLE 5

| | | | | Default | |
|---|---|---|---|---|---|
| | Layout | Layout | Queue | setting | Group |
| Index | ID | name | name | ON | ID |
| 0 | LYT1 | Layout for | Serial No., cyan | GP1 | GP1, |
| | | color | ink/residual toner, | | TSK3 |
| | | machine | . . . | | |
| 1 | LYT2 | Layout for | Serial No., black | GP2 | GP2, |
| | | monochrome | ink/residual toner, | | RP3 |
| | | machine | . . . | | |
| 2 | LYT3 | Layout for | Device model, IP | GP3, | GP3, |
| | | Kawasaki | address, installation | TSK1 | TSK1 |
| | | area | place, . . . | | |

In Table 5, “group ID” in Table 4 is replaced with “related ID,” and a task ID, a report ID, or the like is stored in addition to the device group.

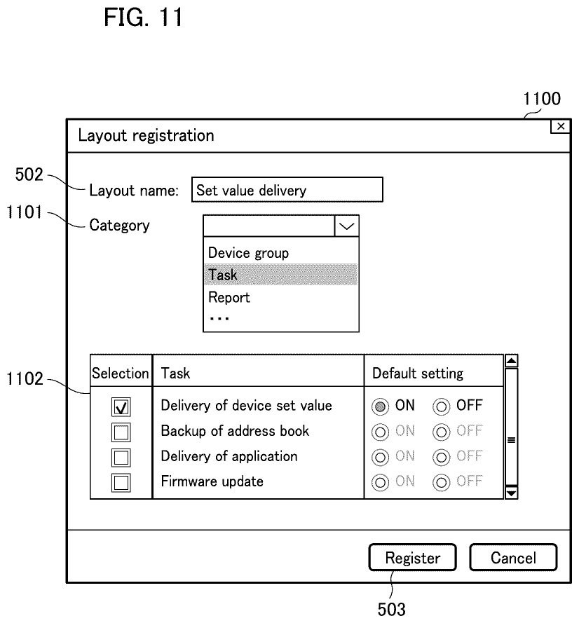

FIG. 11 is a diagram illustrating an example of a layout registration screen of the device management device 102 according to the second embodiment. For the purpose of simplification of explanation, only points related to the present embodiment will be described below.

1100 denotes a layout registration screen which is displayed when the button “layout registration” 405 in FIG. 4 is pushed by a manager. 1101 denotes a category selection and setting area for correlating a layout, and the functions of the device management device 102 can be selected using a combo box.

1102 denotes a setting area for selecting a target to be correlated with a layout. In the present embodiment, description is based on the premise that “task” is selected in the category 1101. A task list which can be set by the device management device 102 is displayed in the setting area 1102, and a manager can select an arbitrary task. Similarly to the first embodiment, a default layout can also be set for a task.

By using the layout registration screen 1100 described above with reference to FIG. 11, it is possible to register various functions of the device management device 102 of displaying a device list in correlation with layouts as well as to register a layout of a device group.

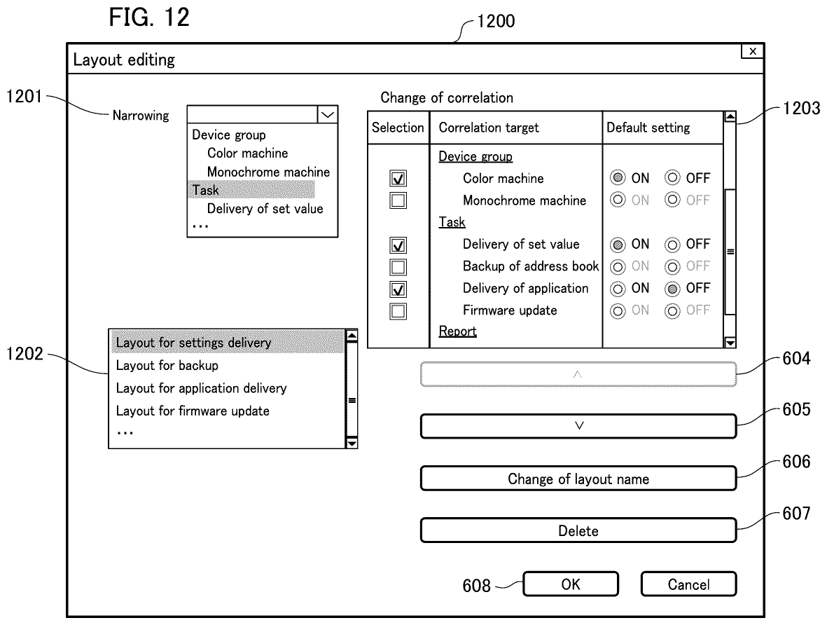

FIG. 12 is a diagram illustrating an example of a UI of the layout information managing unit 330 which is displayed on the display 207 of the device management device 102 according to the second embodiment.

1200 denotes a layout editing screen which is displayed when the button “layout editing” 406 in FIG. 4 is pushed by a manager. 1201 denotes a narrowing area. Device groups or various functions (such as tasks or reports) registered in the device management device 102 can be selected.

1202 denotes a selection and setting area of a layout to be edited. A layout name correlated with the device group or the function (such as a task or a report) selected in the narrowing area 1201 can be selected using a combo box. 1203 denotes a control area for changing correlation settings correlated with a layout to be edited.

Only a device group can be selected in 502 in FIG. 5 according to the first embodiment, but various functions of the device management device 102 such as tasks or reports in addition to a device group can be registered in correlation with layouts. When a device list is displayed using various functions of the device management device 102, the device list is displayed using the process flow of the same flowchart as illustrated in FIG. 9.

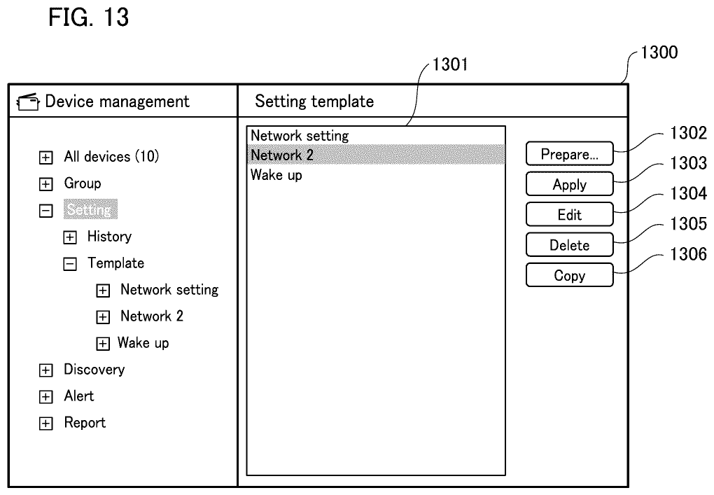

FIG. 13 is a diagram illustrating an example of a UI of the task information managing unit 320 which is displayed on the display 207 of the device management device 102 according to the second embodiment.

A device management area is displayed on the left of a task information management screen 1300. In 1301, a template list is displayed when a “template” menu lower than a “setting” menu in the device management area is selected by a manager (a user).

Templates are also provided in functions (for example, “alert” and “report”) other than “setting” of the management device, and the “setting” function is exemplified in the present mode. The task information management screen 1300 includes a button “preparation” 1302, a button “apply” 1303, a button “edit” 1304, a button “delete” 1305, and a button “copy” 1306.

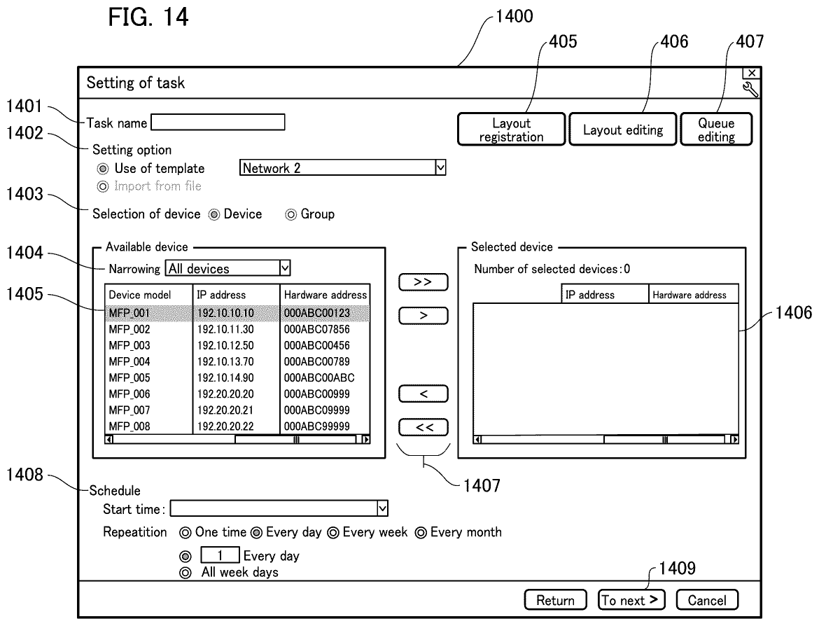

FIG. 14 is a diagram illustrating an example of a UI of the task managing unit 321 which is displayed on the display 207 of the device management device 102 according to the second embodiment. A task management screen 1400 is displayed by allowing a manager to select a template on the task information management screen 1300 and to push the button “apply” 1303.

1401 denotes a task name input area. An arbitrary task name can be input thereto. 1402 denotes a settings option setting area, and, for example, “network 2” which is a template name selected on the task information management screen 1300 is displayed at the time of initial display of the task management screen 1400.

1403 denotes a device selection setting area, and a device or a device group can be selected therein. In the present embodiment, for example, it is assumed that a device is selected. 1404 denotes a narrowing setting area, and devices can be narrowed by selecting a group or the like.

1405 denotes an area in which available devices are displayed and an area in which a device list which is a result of narrowing under the conditions designated in the narrowing setting area 1404. 1406 denotes an area in which IP addresses, hardware addresses, or the like of the selected devices are displayed.

1407 denotes a button for an operation of moving a device from the display area “available devices” 1405 to the display area “selected device” 1406 or a reverse operation thereof. Buttons “>>” and “<<” are always valid and can move all devices. Buttons “>” and “<” are valid only when an arbitrary device is selected and can move only the selected device.

1408 denotes a schedule setting area, and a task execution schedule can be set using the UI displayed in the schedule setting area 1408.

The button “layout registration” 405, the button “layout editing” 406, and the button “queue editing” 407 described above with reference to FIG. 4 are provided in the task management screen 1400, and queue editing or layout registration in correlation with a task is possible similarly to the device information management screen 400 illustrated in FIG. 4. The layout of the display area “available devices” 1405 and the display area “selected device” 1406 is displayed using the layout set for the tasks.

1409 denotes a button “to next.” When this button is pushed, a task is registered under the conditions set on the task management screen 1400.

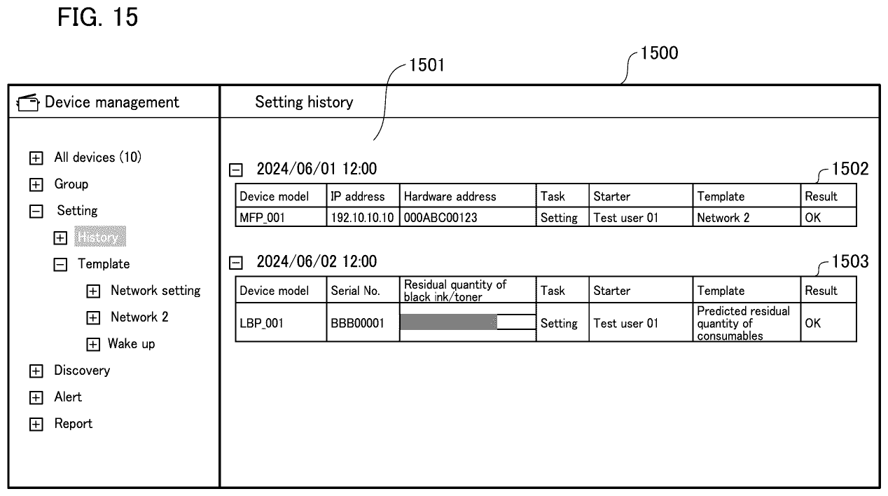

FIG. 15 is a diagram illustrating an example of a UI of the task managing unit 321 which is displayed on the display 207 of the device management device 102 according to the second embodiment.

1500 denotes a task history screen, and a device management area is displayed on the left of the task history screen 1500. 1501 denotes an area in which a task history list is displayed when a “history” menu lower than a “setting” menu in the device management area is selected by a manager.

The task history screen 1500 displays status and results of tasks registered on the task management screen 1400. The task history list is displayed using the layout registered in correlation with tasks on the task management screen 1400.

1502 denotes an example in which tasks registered using a “network 2” template are displayed using the layout set in the tasks. 1503 denotes an example in which tasks registered using a “predicted residual of consumables” are displayed using the layout set in the tasks.

In this way, in the present embodiment, the layout managing unit 331 which is a layout managing means can register layouts in correlation with tasks managed by the task information managing unit 320 which is a task information managing means. A device list can be displayed using the layout at the time of display of tasks.

As described above, it is possible to register various functions of displaying a device list in the device management device 102 in correlation with layouts through the UIs illustrated in FIGS. 11 to 15. When a default layout is registered for an arbitrary function, it is possible to display a device list using the previously registered layout at the time of display of the device list using that function. Accordingly, it is possible to easily use registered layouts according to the purposes.

### Third Embodiment

In the first embodiment and the second embodiment, layouts are registered and used in correlation with device groups or various functions. There are a plurality of attributes (queues) which can be selected in layout registration, and there are attributes which cannot be acquired according to devices.

For example, when a device is registered in a monochrome machine group, attributes of color inks/toners cannot be acquired from the device. However, in the method according to the first embodiment and the second embodiment, since attributes (queues) of color inks/toners can also be selected at the time of layout registration in correlation with the monochrome machine group, a layout in which attributes (queues) not necessary to be displayed are selected may be erroneously registered.

In the third embodiment, a method of not displaying insignificant attributes (queues) even when the attributes (queues) are selected at the time of layout registration and more simply performing layout registration will be described. In the third embodiment, an example of a device model table which is managed by the device data storage unit 312 is shown in Table 6.

TABLE 6

| | Device | |
|---|---|---|
| Index | model | Acquirable attributes |
| 0 | MFP_001 | Status, residual quantity of cyan ink/toner, number of |
| | | exchanges of cyan ink/toner, . . . |
| 1 | MFP_002 | Status, residual quantity of cyan ink/toner, number of |
| | | exchanges of cyan ink/toner, . . . |
| 2 | LBP_001 | Status, residual quantity of black ink/toner, number of |
| | | exchanges of black ink/toner, . . . |

In Table 6, device models managed by the device management device 102 are recorded one by one record, and one device model ID is provided as identification information issued by the device management device 102. In Table 6, attributes which can be acquired by the device management device 102 from the device model is stored as “acquirable attributes” information.

Records of the device models are registered in the device data storage unit 312 in advance, and a UI for registering records of device models may be provided. When a new device is searched for by the device search unit 311, a record of a device model may be registered by identifying the device model of the searched device and detecting acquirable attributes from the device. The method of registering records of device models is not limited to the example.

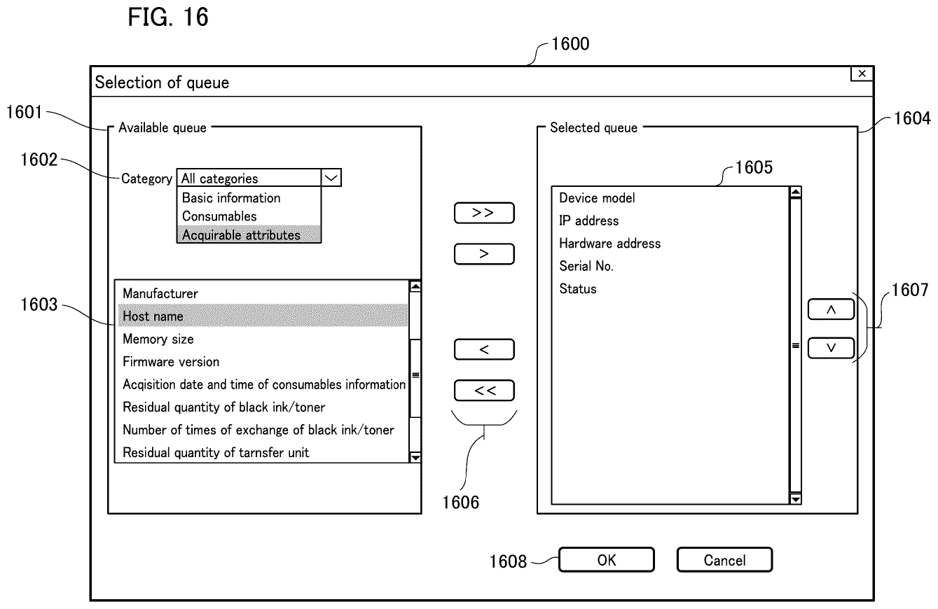

FIG. 16 is a diagram illustrating an example of a UI of the layout information managing unit 330 which is displayed on the display 207 of the device management device 102 according to the third embodiment.

1600 denotes a queue editing screen which is displayed when the button “queue editing” 407 in FIG. 4 is pushed by a manager (a user). An editing target is a layout which is applied to the device list 403 in FIG. 4. The button “queue editing” 407 is not limited to the device information management screen 400 and may be displayed in the UI of the task information managing unit 320 or the UI of the report information managing unit 340, and a layout applied at the time of pushing of the button “queue editing” 407 is an editing target thereof.

1601 denotes a queue selection area which can be used for layout editing, and 1602 denotes an area for narrowing queue names by categories. The categories defined in the device management device 102, for example, “acquirable attributes” in addition to “basic information” and “consumables” can be narrowed.

1603 denotes a queue name selection area. A list of selectable queue names changes according to the category selected in the queue selection area 1602. One or more queue names can be selected in the queue name selection area, and a queue name which is used as a layout is determined using a button 1606 which will be described later.

1604 denotes an area in which a “selected queue” selected in the layout to be edited is displayed. A list of queue names used in the layout applied at the time of pushing of the button “queue editing” 407 is initially displayed. 1605 denotes a display area of the selected queue name.

1606 denotes a button for an operation of moving a queue name from the area “available queues” 1603 to the area “selected queue” 1605 or a reverse operation thereof. Buttons “>>” and “<<” are always valid and can move all queue names. Buttons “>” and “<” are valid only when an arbitrary queue name is selected and can move only the selected queue name.

1607 denotes a button for changing the display order of queue names in the area “selected queue” 1605. 1608 is an “OK” button. When this button is pushed, the queues are edited under the conditions set on the queue editing screen 1600, and the previous screen is displayed in the edited queue names.

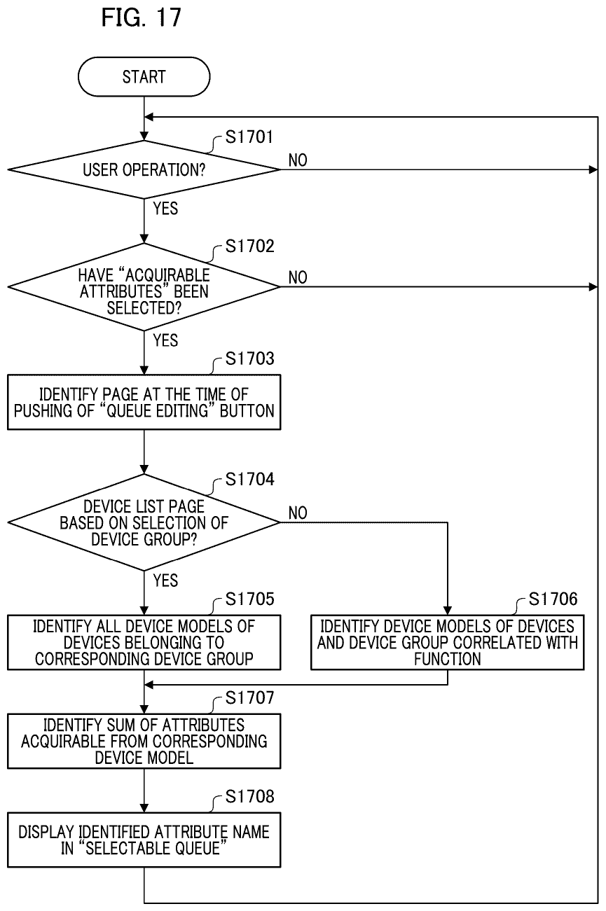

FIG. 17 is a flowchart illustrating an example of a queue identifying flow that is performed by the layout managing unit according to the third embodiment. A method of identifying a list of queue names which is displayed when “acquirable attributes” are selected as the category 1602 will be described in detail with reference to the flowchart of FIG. 17.

The operations of the steps in the flowchart illustrated in FIG. 17 are sequentially performed by causing the CPU which is a computer in the device management device 102 or the like to execute a computer program stored in a memory. For the purpose of simplification of explanation, only points related to the present embodiment will be described below.

In Step S1701, a user operation is received. That is, it is determined whether an operation on the queue editing screen 1600 has been performed using the pointing device 209, the keyboard 206, or the like by a manager (a user), and the process flow returns to Step S1701 when the determination result is NO. On the other hand, when the determination result of Step S1701 is YES, it is determined in Step S1702 whether “acquirable attributes” have been selected by the operation.

When it is determined in Step S1702 that “acquirable attributes” have been selected by the operation, a page at the time of pushing of the button “queue editing” is identified in Step S1703. In Step S1704, it is determined whether the page identified in Step S1703 is a device list page based on selection of a device group.

When the determination result of Step S1704 is YES, all device models of the devices belonging to the device group are identified in Step S1705. On the other hand, when the determination result of Step S1704 is NO, all the device models of the device and the device group correlated with a function are identified in Step S1706.

Subsequently, in Step S1707, a sum of attributes acquirable from all the device models identified in Steps S1705 and S1706 is identified. In Step S1708, all the attributes identified in Step S1707 are displayed in the “available queues” 1603 in FIG. 16.

In this way, in the present embodiment, device models of devices displayed at the time of input of a layout editing request are identified through the flowchart illustrated in FIG. 16 or 17. Attribute values acquirable from the identified device models are identified, and only the identified attribute values are used as a layout editing target.

Accordingly, it is possible to use only attributes acquirable from the devices displayed in the page before displaying the queue editing screen 1600 or only attributes acquirable from devices correlated with a device group as a queue editing target. As a result, it is possible to more simply prepare a layout without any miss.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the device management device or the like through a network or various storage media. Then, a computer (or a CPU, an MPU, or the like) of the device management device or the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-040754, filed on Mar. 13, 2025, which is hereby incorporated by reference herein in its entirety.

What is claimed is:

1. A device management device that performs registration and management of tasks, the device management device comprising:
at least one processor; and
a memory coupled to the at least one processor, the memory storing instructions that, when executed by the at least one processor, cause the at least one processor to perform:
managing devices to be managed by groups;
managing the tasks to be executed for each device group;
editing a layout at the time of displaying a device list and registering the layout in correlation with a predetermined device group; and
displaying the device list on the basis of the layout registered through the managing of a layout.

2. The device management device according to claim 1, wherein the layout is registered in correlation with the tasks to be managed.

3. The device management device according to claim 2, wherein the device list is displayed using the layout at the time of displaying the tasks.

4. The device management device according to claim 1, wherein a device model of a device displayed at the time of requesting for editing a layout is identified, an attribute value which is acquirable from the identified device model is identified, and only the identified attribute value is used as a layout editing target.

5. A device management method of performing registration and management of tasks, the device management method comprising:
managing devices to be managed by groups;
managing the tasks to be executed for each device group;
editing a layout at the time of displaying a device list and registering the layout in correlation with a predetermined device group; and
displaying the device list on the basis of the layout registered through the managing of a layout.

6. A non-transitory computer-readable storage medium configured to store a computer program comprising instructions for executing the following processes: in order to perform registration and management of tasks,
managing devices to be managed by groups;
managing the tasks to be executed for each device group;
editing a layout at the time of displaying a device list and registering the layout in correlation with a predetermined device group; and
displaying the device list on the basis of the layout registered through the managing of a layout.
